(19) United States
(12) Patent Application Publication
(10) Pub. No.: US 2015/0380148 A1
(43) Pub. Date: Dec. 31, 2015

(54) METHODS AND SYSTEMS FOR FORMING AMORPHOUS METAL TRANSFORMER CORES

(71) Applicant: LAKEVIEW METALS, INC., Antioch, IL (US)

(72) Inventor: Kevin C. Looby, Wadsworth, IL (US)

(21) Appl. No.: 14/769,197

(22) PCT Filed: Mar. 11, 2014
(86) PCT No.: PCT/US14/23073

§ 371 Date: Aug. 20, 2015

Related U.S. Application Data
(60) Provisional application No. 61/778,621, filed on Mar. 13, 2013.

(51) Int. Cl. H01F 27/25; H01F 1/153; H01F 27/26; H01F 41/02

(52) U.S. Cl. CPC H01F 27/25; H01F 41/0226; H01F 1/153; H01F 27/263

(57) ABSTRACT

An annealed amorphous metallic transformer core comprising a plurality of amorphous metallic strip packets. The plurality of amorphous metallic strip packets are shaped into a metallic transformer core. The metallic transformer core comprises a back of said core, and an overlap or front of said core. A first leg of the amorphous core extends from the back of the core to the front of the core. A second leg of the amorphous core extends from the back of the core to the front of the core. A first cap is provided along at least a portion of the first leg of the amorphous core, the cap providing straightness and/or rigidity to the plurality of amorphous metallic strip packets contained within the leg of the amorphous core.

### CROSS-REFERENCE

This application claims priority to U.S. Provisional Patent Application Ser. No. 61/778,621 filed Mar. 13, 2013, incorporated herein by reference.

### BACKGROUND

1. Field of the Present Patent Disclosure

The present disclosure is generally directed to shaping or forming a transformer core (e.g., an annealed transformer core) comprising a plurality of amorphous metal strips. Specifically, the present disclosure is generally directed to a method and systems for shaping an annealed electric transformer core comprising a plurality of metallic strip packets or groups, wherein each packet or group may comprise a plurality of thin amorphous metal strips. These thin strips of amorphous metal are arranged in a collection of packets or groups comprising multiple-strip lengths. These collections may then be arranged to surround steel plates to form a rectangular or square shape known as the core window. Thereafter, after the completed core has been formed, the amorphous core may be energized with a magnetic field while undergoing an annealing process. The annealing process results in a core which has magnetic properties which are highly desirable for use in electrical transformers. The annealed amorphous core then undergoes a testing procedure wherein certain known electrical properties of the now annealed core are tested. If the annealed core passes such tests, the core then undergoes a finishing step wherein the shape and dimensions of the core as defined by the steel plates, as well as the overall containment of the annealed amorphous material is secured. In one arrangement, the annealed core undergoes a finishing step wherein the shape and dimensions of the core as defined by a cap placed along at least a portion of a leg of the core. The cap may comprise an oil-compatible, paper-like material. Alternatively, the cap may comprise a layer of epoxy along at least a portion of a top surface or cast edge of a core leg. Tape may be provided over the cap. However, aspects of the present application may be equally applicable in other scenarios as well.

2. Description of Related Art

Electrical-power transformers are used extensively in various electrical and electronic applications. For example, as is generally known in the art, transformers transfer electric energy from one circuit to another circuit through magnetic induction. Transformers are also utilized to step electrical voltages up or down, to couple signal energy from one stage to another, and to match the impedances of interconnected electrical or electronic components. Transformers may also be used to sense current, and to power electronic trip units for circuit interrupters. Still further, transformers may also be employed in solenoid-equipped magnetic circuits, and in electric motors.

A typical transformer includes two or more multi-turned coils of wire commonly referred to as “phase windings.” The phase windings are placed in close proximity to one another so that the magnetic fields generated by each winding are coupled when the transformer is energized. Most transformers have a primary winding and a secondary winding. The output voltage of a transformer can be increased or decreased by varying the number of turns in the primary winding in relation to the number of turns in the secondary winding.

The magnetic field generated by the current passing through the primary winding is typically concentrated by winding the primary and secondary coils on a core of magnetic material. This arrangement increases the level of induction in the primary and secondary windings so that the windings can be formed from a smaller number of turns while still maintaining a given level of magnetic-flux. In addition, the use of a magnetic core having a continuous magnetic path helps to ensure that virtually all of the magnetic field established by the current in the primary winding is induced in the secondary winding. An alternating current flows through the primary winding when an alternating voltage is applied to the winding. The value of this current is limited by the level of induction in the winding.

The current produces an alternating magnetomotive force that, in turn, creates an alternating magnetic flux. The magnetic flux is constrained within the core of the transformer and induces a voltage across the secondary winding. This voltage produces an alternating current when the secondary winding is connected to an electrical load. The load current in the secondary winding produces its own magnetomotive force that, in turn, creates a further alternating flux that is magnetically coupled to the primary winding. A load current then flows in the primary winding. This current is of sufficient magnitude to balance the magnetomotive force produced by the secondary load current. Thus, the primary winding carries both magnetizing and load currents, the secondary winding carries a load current, and the core carries only the flux produced by the magnetizing current.

Certain modern transformers generally operate with a high degree of efficiency. Magnetic devices such as transformers, however, undergo certain losses because some portion of the input energy to the transformer is inevitably converted into unwanted losses such as heat. A most obvious type of unwanted heat generation is ohmic heating—heating that occurs in the phase windings due to the resistance of the windings.

Traditionally, electrical transformer cores have been formed completely of grain oriented silicon steel laminations. Over the years, improvements have been made in such grained oriented steels to permit reductions in transformer core sizes, manufacturing costs and the losses introduced into an electrical distribution system by the transformer core. As the cost of electrical energy continues to rise, reductions in core loss have become an increasingly important design consideration in all sizes of electrical transformers.

In order to further reduce these performance losses in transformers, amorphous metals having a non-crystalline structure, lower iron losses and higher permeability, have been used in forming electromagnetic devices, such as amorphous metal cores that can be used for electrical transformers. Generally, amorphous metals have been used because of their superior electrical characteristics relative to grain oriented silicon steel laminations. For this reason, amorphous ferromagnetic materials are being used more and more frequently as transformer base core materials in order to reduce undesired transformer core operating losses.

Generally, amorphous metals may be characterized by a virtual absence of a periodic repeating structure on the atomic level, i.e., the crystal lattice. The non-crystalline amorphous structure is produced by rapidly cooling a molten alloy of appropriate composition such as those described by Chen et al., in U.S. Pat. No. 3,856,513, herein incorporated by reference and to which the reader is directed for further information. Due to the rapid cooling rates, the alloy does not form in the crystalline state. Rather, the alloy assumes a metastable non-crystalline structure representative of the liquid phase from which the alloy was formed. Due to the absence of crystalline atomic structure, amorphous alloys are frequently referred in certain literature and elsewhere as “glassy” alloys.

Certain known methods and/or systems for manufacturing amorphous metal transformer cores are known. As just one example, U.S. Pat. No. 5,285,565 entitled “Method for Making a Transformer Core Comprising Amorphous Steel Strips Surrounding The Core Window” herein entirely incorporated by reference and to which the reader is directed for further reference, teaches such a method and system for making a transformer core wherein the transformer core comprises a plurality of groupings of amorphous metal strips. As described in U.S. Pat. No. 5,285,565, the disclosed method utilizes a plurality of spools of amorphous steel strip in each of which the strip is wound in a single-layer thickness. For example, and as illustrated in FIG. 1 of U.S. Pat. No. 5,285,565, a pre-spooler comprising five starting spools is illustrated. As the inventors describe in this patent, the strip from the five starting spools must first be unwound and then re-wound onto the pre-spooler. In this manner, the five single ply spools are unwound so as to create a five (5) ply ribbon or strip that then must be wound onto the pre-spooler.

One of the challenges faced by manufacturers of such amorphous transformer cores has to do with the nature of the amorphous metal strips themselves. For example, due to the nature of the manufacturing process, an amorphous ferromagnetic strip suitable for winding a distribution transformer core is extremely thin. For example, the thickness of a typical amorphous metallic strip may nominally be on the order of 0.23 mm versus a thickness of approximately 0.250 mm for typical grain oriented silicon steel. Moreover, such amorphous metallic strips are quite brittle and are therefore easily damaged or fractured during the processing, the annealing, and the handling of such strips. Consequently, the handling, processing, fabrication, annealing and shaping of wound amorphous metal cores presents certain unique manufacturing challenges of handling the very thin strips. This is particularly present throughout the various manufacturing steps of winding the core, cutting and rearranging the core laminations into a desired joint pattern, annealing and then shaping the core, and finally lacing the core through the window of a preformed transformer coil.

Of particular importance is the lacing step which must be effected with heightened care so as to avoid permanently deforming the core from its annealed configuration after the annealed core has past its electrical testing and after the annealed core has been laced into the coil window. That is, if the annealed core is not returned to its annealed shape and orientation, stresses may be introduced onto the amorphous metallic strips making up the core during the lacing procedure. Consequently, if there are significant stresses remaining after lacing, the low core loss characteristic offered by the amorphous metal core material is diminished. Since annealed amorphous metal laminations are quite weak and have little resiliency, they are readily disoriented during the lacing step, resulting in core performance degradation if not corrected. In addition to this concern, there is also a potential concern that the lacing step is carried out with sufficient care such as to avoid fracturing the brittle amorphous metal laminations.

The relatively thin ribbons of amorphous metals present certain core manufacturing challenges during the handing, processing, assembly and annealing of such amorphous metal transform cores. As just one example, certain amorphous metal transformer cores generally require a greater number of laminations or groupings or stacks of strips in order to form a desired amorphous metal core. As such, amorphous metal cores comprising a larger number of laminations tend to present certain difficulties and challenges in handling during the various processing steps that may be involved as the plurality of metallic strip groupings and collections are eventually processed, sheared, and then formed into an amorphous metal core.

In addition, the magnetic properties of the amorphous metals have been found to be deleteriously affected by mechanical stresses. Such mechanical stresses may be introduced during the fabricating and finishing steps of winding, forming, and final shaping (via epoxy or tape) the amorphous metal groupings and stacks into a desired core shape.

To facilitate the movement of the core through the various annealing, testing and epoxying process steps, a plurality of inner and outer core support plates are typically used in attempt to maintain the overall structure of the core while keeping both the outer walls and the inner walls of the core straight. For example, ordinarily a total of eight (8) support plates are typically provided so as to maintain the structural integrity and containment of the core during these further process steps. These support plates comprise four outer support plates and four inner support plates. In this example, two longer outer support plates are provided along the outer legs or side legs of the core. Similarly, two longer inner support plates are provided along the inner legs of the core. In a similar manner, two shorter outer support plates are provided at opposite ends of the core along the inner or side legs. In order to maintain these supporting plates in a supporting position, a metallic band is provided along an exterior of the supported core so that the plurality of support plates and hence the core are maintained or contained in a relatively fixed position. Essentially, these various support plates sandwich the core walls between the inner and outer plates and thereby provide a certain desired definition to the core walls. Importantly, the various support plates are typically used to sandwich the core walls; such that the plurality of amorphous metal strips and strip packets making up the inner and outer core walls are maintained in a uniform and straight fashion and the core walls are defined at a specific thickness, known as buildup.

For example, once an annealed amorphous transformer core has gone through an annealing process by being treated in a heated oven, the annealed core may then undergo certain testing to determine the operating characteristics of the annealed core. For example, an annealed core is typically tested to verify that the annealed core is below the maximum watts and maximum Volt Amperes (amps*test voltage=VA) at a specific induction level. If the annealed core does not pass certain test procedures, it could be due to a number of different causes such as a bad bus bar connection, an incorrect annealing temperature, improper length of time at the proper annealing temperature, etc. If the annealed amorphous core tests poorly due to inadequate time or temperature in the annealing oven, certain cores can be recovered by undergoing yet another annealing process.

Assuming that the annealed core passes its testing procedures, the various supporting plates must then be removed and the shape and dimensions of the annealed transformer core must then be secured so that the transformer core can then be packaged for transportation or assembled in a transformer. Importantly, the annealed transformer core must be transported and inserted into the coils without losing the shape and dimensions it was in while undergoing the annealing process. As such, it is generally desired that prior to packaging and shipment, the shape of the annealed core must be secured so as to maintain its annealed (and therefore tested) shape.

Epoxy Shaping Method

Currently, after an amorphous core has been annealed, the core must be provided with a manner so that the core retains a certain degree of its annealed shape after the supporting plates are removed. One common method of provided such a shape support structure is by using one or more layers of epoxy provided along certain surfaces of the annealed core. In this method, the top and bottom surfaces of the core are covered with an epoxy with the exception of the overlap area which must remain opened and re-laced when the conductor coils are slipped on the core.

One generally known method for maintaining the annealed shape of the transformer core is to cover the majority of the top and bottom edges of the core walls with one or more layers of epoxy so as to provide structural strength and chip containment of the core. For example, FIG. 4 illustrates such an epoxy core comprising an epoxy covering. As illustrated in FIG. 4, a top surface of the core as well as a core backwall is provided with one or more layers of epoxy. The top and bottom surfaces of the annealed core will be provided with such an epoxy treatment. The only portion of the annealed core that will not have an epoxy treatment is the core overlap area towards the front of the core. The overlap of the core is not provided with epoxy as this portion of the annealed core must remain open so that the core can be re-laced when the conductor coils are slipped onto the core. One reason that epoxy is used is that it provides the annealed core with a certain degree of structural support.

However, application of such an epoxy treatment presents certain disadvantages. For example, before the epoxy is applied, the overlap area of the core must be taped off so that the epoxy is administered properly along only certain outer surfaces of the annealed core. As just one example, one known method of epoxy treating annealed cores requires the following tedious and time consuming process steps:
a. De-stress the annealed transformer core and perform a first electrical test;
b. Check amorphous core wall buildup so as to verify that the wall buildup thickness meets design specification;
c. Apply masking tape to the core overlap area so as to prevent epoxy from entering overlap area;
d. Apply masking tape around inner and outer sides of entire core wall to prevent epoxy from sticking to both sides of the core wall;
e. Apply epoxy to the cast edge of core wall;
f. Cure the annealed core with first layer of epoxy in oven;
g. Apply a second coat of epoxy to the cast edge of the core wall;
h. Cure entire annealed core for a second time with the second layer in oven;
i. Wait for annealed core to cool and then manually trim and remove excess epoxy and tape from the core sides;
j. Remove tape from the core overlap area;
k. Flip annealed and now partially epoxied core to other side;
l. Check buildup;
m. Apply masking tape to protect core overlap area from epoxy application;
n. Apply masking tape around inner and outer sides of entire core wall to prevent epoxy from sticking to both sides of the core wall;
o. Apply first coat of epoxy along cast edge of core wall;
p. Cure entire annealed core for a third time with first new layer of epoxy in oven;
q. Apply a second coat of epoxy;
r. Cure entire annealed core for a fourth time with second new layer of epoxy in oven;
s. Wait for annealed core to cool and then manually trim and remove excess epoxy along window of the annealed core;
t. Manually remove tape from the core overlap area;
u. Remove support plates;
v. Check buildup;
w. Remove heat-resistant tape from outside overlap area; and then
x. Perform final electrical test.

The epoxy serves to contain any amorphous chips inside the core, and provide structure to the core and rigidity to the core legs, as the amorphous sheets of which the core is composed are quite flexible and will not readily hold shape of their own. As explained in greater detail, one disadvantage of applying one or more epoxy layers to the entire core leg and backwall is that this is a very costly process involving extensive labor as well as epoxy, tape, and disposable razor trimmer costs. Moreover, the epoxy provides no dimensional definition to the packets making up the core leg.

Another disadvantage of the epoxy process is that, at final buildup test when inner and outer plates are removed, if the core wall buildup is out of dimensional tolerance, then the whole core must be scrapped.

Another disadvantage of applying one or more epoxy layers to the entire core leg and backwall is that the various layers of the cured epoxy prevent the amorphous ribbon from moving in response to the magnetostrictive forces induced by the conductor coils. Amorphous materials become more resistant to magnetic flux when they are prohibited from moving in relation to magnetostriction.

Another disadvantage of the epoxy method is that often times, after a core has passed its electrical test after the annealing phase, the annealed core will fail its test after the epoxy has been applied. In certain instances, annealed core failures may occur because the one or more layers of the cured epoxy permanently deforms the annealed core from its annealed configuration as a result of shrinkage of the epoxy during curing, or inadequate maintenance of core shape and dimensions during the epoxy process. That is, if the annealed core is not returned to its annealed shape, stresses may be introduced after repeated epoxy application and curing procedures. Consequently, if there are significant stresses remaining after the application of the epoxy, the potential low core loss characteristic offered by the amorphous metal core material may not be achieved. A core with higher than acceptable losses must be scrapped.

Another disadvantage of the epoxy application method is that, after the final epoxy curing process step, the annealed cores must be manually trimmed so as to remove any excess epoxy along top and bottom of the annealed core. A certain degree of heightened care must be exercised during this epoxy removal step from the core inner and outer walls as failure to remove excess epoxy or a failure to properly remove any excess epoxy from this area may lead to scratches in the coil insulation and hence transformer failure. Of course, the excess tape and epoxy waste must be disposed of and therefore results in an environmental burden.

Tape Shaping Methods

In an attempt to overcome the various performance degradations that may be induced by this epoxy application method and its suspension of movement of the amorphous ribbon along with the laborious task of tape and excess epoxy removal process steps, a number of alternatives to this annealed core shaping process have been suggested. For example, one alternative to using epoxy is an attempt to provide annealed core support by loosely manually wrapping the core legs with lose or non-tensioned insulating paper in a spiral fashion like that of a candy cane, grip tape on a bicycle handlebar, or the grip on a baseball bat. In this manner, each successive wrap of the insulating paper would partially overlap the prior wrap. Typically, the wraps may be applied starting near the core overlap area, progress away from the annealed core overlap area along a first leg of the core, around the core, and then back near to the overlap area along the second leg of the core. Where the insulating paper begins and ends, it can be held in place with gummed tape. While this spiral taping method may serve to let the amorphous material move in response to the magnetorestrictive forces induced by the conductor coils, it is a laborious method and consequently an expensive, time consuming process. In addition, for certain sized amorphous cores, it has been found that such a spiral taping method provides insufficient support of the legs of the transformer core thereby making the handing of such taped amorphous cores difficult, such as during handling or when inserting the core into the transformer coils.

Another disadvantage that might be experienced from such a spiral taping method is that, in order to gain core leg stability, the legs must be wound tightly. However, the cumulative pressure on the various stacks of the amorphous ribbon created by the paper restricts magnetostrictive motion, and can therefore (like the epoxy method mentioned above) significantly degrade overall core (and hence transformer) performance. Another disadvantage of such a taping method is that it is difficult to manipulate the annealed amorphous core so as to repeatedly wrap the tape around the complete core. For example, many times such amorphous cores may weigh upwards from approximately 1,000 pounds and therefore such typical amorphous transformer cores can only be moved and/or re-positioned along a work surface by operation of a large crane. As such, this increases the overall labor burden for using such a tape oriented core processing step. Moreover, taping of the core provides no dimensional definition to the packets making up the core leg.

Gummed Tape Shaping Method

Another alternative annealed core shaping method to using epoxy is to provide core rigidity and strength by wrapping the annealed core as described above, while using a gummed tape for the entire wrapping process around the length of the core, except for the core overlap area. In this manner, the gummed tape may be applied as a plurality of individual pieces, where each piece of tape may overlap one another or the tape may comprise a single continuous piece that wraps around the legs of the core and comes back to cover itself.

With such a gummed taping method, however, there are also a number of disadvantages. One disadvantage of such a gummed tape method is that application of the various taping is a very time-consuming process and has, therefore, further drawbacks. First, the tape application method is a slow and labor-intensive process. Second, the pressure exerted on the amorphous core from applying repeated tape applications tends to accumulate, as more and more tape is applied to the annealed transformer core. This cumulative effect causes an increase in pressure on the amorphous ribbon within the core and consequently results in an unwanted degradation in performance by preventing magnetostrictive motion of the annealed core. Third, the gummed tape is expensive. Fourth, the gummed tape, when applied in loose manner so as to attempt to minimize preventing the desired magnetostrictive motion, does not provide adequate support, structural containment, or dimensional definition for the core legs making handling and insertion of the core into the coils difficult. Fifth, there is no straight edge to reference the core leg against while applying the tape, making it very easy to shape the core leg in a crooked manner.

There is, therefore, a need for a more cost effective and less labor intensive method of shaping an annealed amorphous core in an environmentally friendly manner. Such a desired cost effective and less labor intensive core shaping method should also offer a certain desired degree of core rigidity and containment while also increasing manufacturing facility throughput. Such a cost effective and less labor intensive core shaping technique should also allow for maintaining the inner and outer core walls in a uniform and straight fashion, and particularly achieving such uniform and straight positioning of the amorphous core packets while also achieving a specified core buildup dimension. Achieving such uniform and straight dimensional definition of the amorphous core packets also allows for easier insertion of the annealed core into a transformer coil.

There is also a need for an annealed amorphous core shaping technique that provides adequate core support and core containment while also allowing the amorphous core to achieve its desired magnetostrictive motion. There is also a general need for an annealed amorphous core shape definition technique that provides improved core support and containment while also reducing undesired transformer core operating losses while also reducing potential damage to the core that may result when removing excess epoxy.

These as well as other advantages of various aspects of the present disclosure will become apparent to those of ordinary skill in the art by reading the following detailed description, with appropriate reference to the accompanying drawings.

### SUMMARY

According to an exemplary embodiment, an annealed amorphous metallic transformer core comprising a plurality of amorphous metallic strip packets is disclosed. The plurality of amorphous metallic strip packets are assembled into a metallic transformer core, wherein the metallic transformer core comprises a back of the core, an overlap or front portion of the core, a first leg of the amorphous core extending from the back of the core to the front of the core, and a second leg of the amorphous core extending from the back of the core to the front of the core. A first cap is provided along at least a portion of the first leg of the amorphous core. The cap providing rigidity and/or straight linear definition to the plurality of amorphous metallic strip packets contained within the leg of the amorphous core.

These as well as other advantages of various aspects of the present patent disclosure will become apparent to those of ordinary skill in the art by reading the following detailed description, with appropriate reference to the accompanying drawings.

### BRIEF DESCRIPTION OF THE DRAWINGS

Exemplary embodiments are described herein with reference to the drawings, in which:

FIG. 1 illustrates a side view of a group or a packet of metal strips for assembly into an amorphous transformer core;

FIG. 2 illustrates a top plan view of the packet of metallic strips illustrated in FIG. 1;

FIG. 3 illustrates an annealed transformer core having a joint construction, utilizing a plurality of the packet of metallic strips illustrated in FIGS. 1 and 2;

FIG. 4 illustrates a perspective view of an annealed amorphous core that has been formed with epoxy;

FIG. 5A illustrates a perspective view of one cap arrangement, that may be used to form an annealed amorphous core such as the core illustrated in FIG. 3;

FIG. 5B illustrates a side view of the cap arrangement illustrated in FIG. 5A;

FIG. 6 illustrates a perspective view of an alternative cap arrangement, that may be used to form an annealed amorphous core such as the core illustrated in FIG. 3;

FIG. 7 illustrates a perspective view of yet another cap arrangement, that may be used to form an annealed amorphous core such as the core illustrated in FIG. 3;

FIG. 8A illustrates a perspective view of another cap arrangement, that may be used to form an annealed amorphous core such as the core illustrated in FIG. 3;

FIG. 8B illustrates a side view of the cap arrangement illustrated in FIG. 8A;

FIG. 9 illustrates a perspective view of an annealed transformer core comprising a cap arrangement, such as the cap arrangement illustrated in FIG. 5A-5B;

FIG. 10 illustrates a perspective view of an annealed transformer core comprising a cap arrangement, such as the cap arrangement illustrated in FIG. 5A-5B;

FIG. 11A illustrates a perspective view of an annealed transformer core comprising an alternative cap arrangement;

FIG. 11B illustrates a side view of an alternative cap arrangement illustrated in FIG. 12A;

FIG. 11C illustrates a side view of the annealed transformer core comprising the alternative cap arrangement illustrated in FIG. 11A;

FIG. 12 illustrates an exemplary flow chart identifying certain steps for a method of shaping an annealed amorphous core, such as the core illustrated in FIG. 3;

FIG. 13 illustrates a perspective view of an annealed core prior to performing a preferred shaping method, such as the method describe in the flow chart of FIG. 12;

FIG. 14 illustrates a perspective view of an annealed core prior during an initial process step of a preferred shaping method, such as the method describe in the flow chart of FIG. 12; and

FIG. 15 illustrates yet another perspective view of an annealed core prior during a process step of a preferred shaping method, such as the method describe in the flow chart of FIG. 12.

### DETAILED DESCRIPTION

As is generally known in the art, an apparatus may be used to manufacture a plurality of groups or packets of amorphous metallic strips that can be further formed into a core and this core may then be used to fabricate an amorphous core transformer. As those of ordinary skill in the art recognize, transformer cores are fabricated from a plurality of grouping of stacks wherein each grouping comprises a plurality of amorphous metal strips. In one alternative preferred arrangement, transformer cores are fabricated from a plurality of groupings wherein one grouping may comprise a plurality of amorphous metal strips and wherein certain other groupings may comprise non-amorphous metal strips (e.g., grain oriented silicon steel). Still further, transformer cores may be fabricated wherein certain groupings may comprise both a plurality of amorphous strips along with non-amorphous metal strips.

Metallic Strip Packets

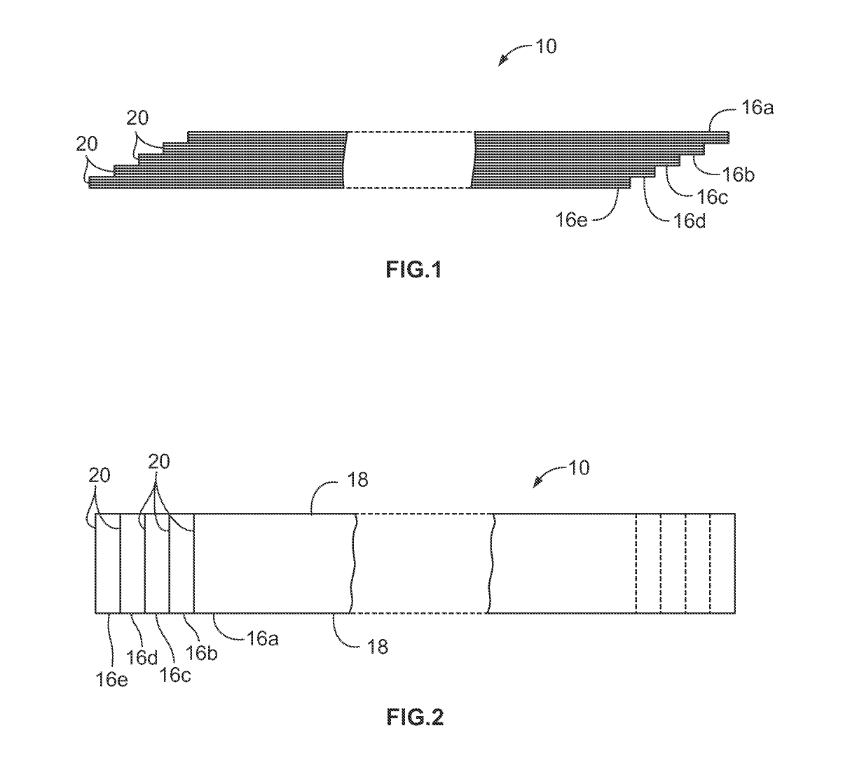

Specifically, and now referring first to FIGS. 1 and 2, there is shown a packet 10 of metallic strips which are manufactured by a generally known apparatus, such as the apparatus described in greater detail in U.S. Pat. No. 5,285,565. As discussed above, this packet 10 may comprise all amorphous metal strips or a combination of amorphous and non-amorphous metal strips (non-grained oriented or grain oriented). This packet 10 comprises a plurality of groups 16 (a-e) of metal strips, each group comprising many thin layers of elongated strip. In this preferred illustrated packet, the packet 10 comprises five (5) groups 16 (a-e) of many thin layers of elongated strips. However, those of ordinary skill in the art will recognize that other packet strip embodiments may also be used.

In addition, preferably, each group 16 (a-e) may comprise a plurality of thin layers of elongated metal strips. As just one example, each group 16 (a-e) comprises 15 (fifteen) thin layers of elongated strip. However, other group and strip arrangements may also be used. For example, group 16 (a-e) may comprise 15 thin layers of elongated strip wherein each one of the 15 layers is uncoiled from each respective uncoiler illustrated in FIG. 1. For example, the first layer 16a may be uncoiled from a first uncoiler, the second thin layer may be uncoiled from a second coiler, etc.

In each group, the layers of metallic strips have longitudinally-extending edges 18 at opposite sides thereof and transversely-extending edges 20 at opposite ends thereof. In each group 16a-e, the longitudinally-extending edges 18 of the strips at each side of the group are aligned. In addition, in each group 16a-e, the transversely-extending edges 20 of the strips at each end of the group are aligned. In the illustrated packets of FIGS. 1 and 2, the groups 16 are made progressively longer beginning at the bottom of the packet 10 (or inside of the packet 10) and proceeding toward the top of the packet (or toward the outside of the packet 10).

The increased length of these groupings of the metallic strips enables the groups 16 (a-e) to completely encircle the increasingly greater circumference of the transformer core form as the core form is built up on the winder section, that is, when the plurality of packets are wrapped about an arbor illustrated in FIG. 1. As described in greater detail below, these packets are wrapped about an arbor with their inside, or shortest, group nearest the arbor. That is, as just one example, for the metallic strip packet 10 illustrated in FIGS. 1 and 2, this packet will be wrapped about the arbor with the inside or shortest metallic group 16e nearest the arbor (i.e., nearest the inner diameter of the transformer core).

Referring still to FIGS. 1 and 2, adjacent groups in each packet 10 have their transversely-extending ends 20a-e staggered so that at one end of the packet the adjacent groups underlap, and at the other end of the packet the adjacent groups overlap. For example, adjacent groups 16a and 16b have their transversely-extending ends staggered so that at one end of the packet the adjacent groups underlap, and at the other end of the packet the adjacent groups overlap. This staggering results in distributed type joints in the final core after they have been wrapped about an arbor.

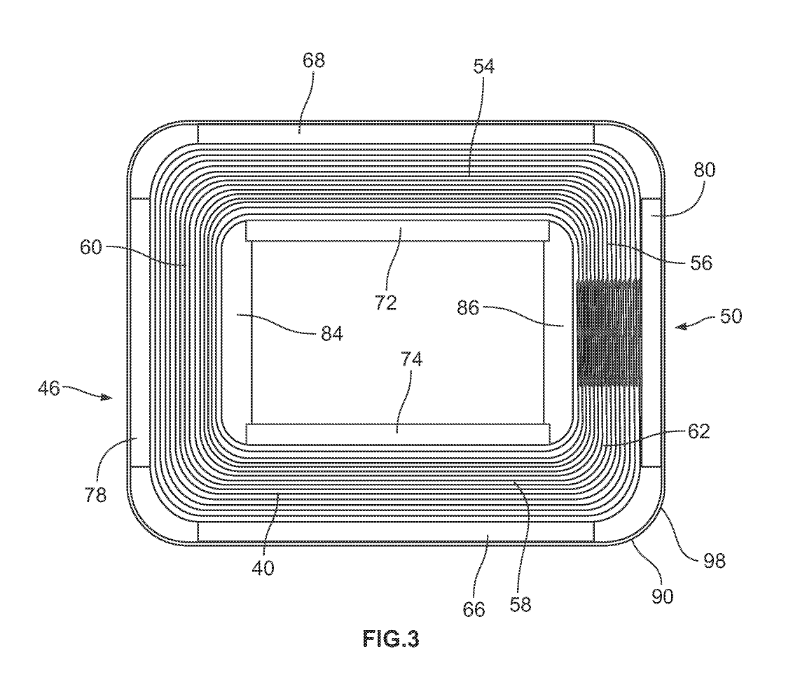

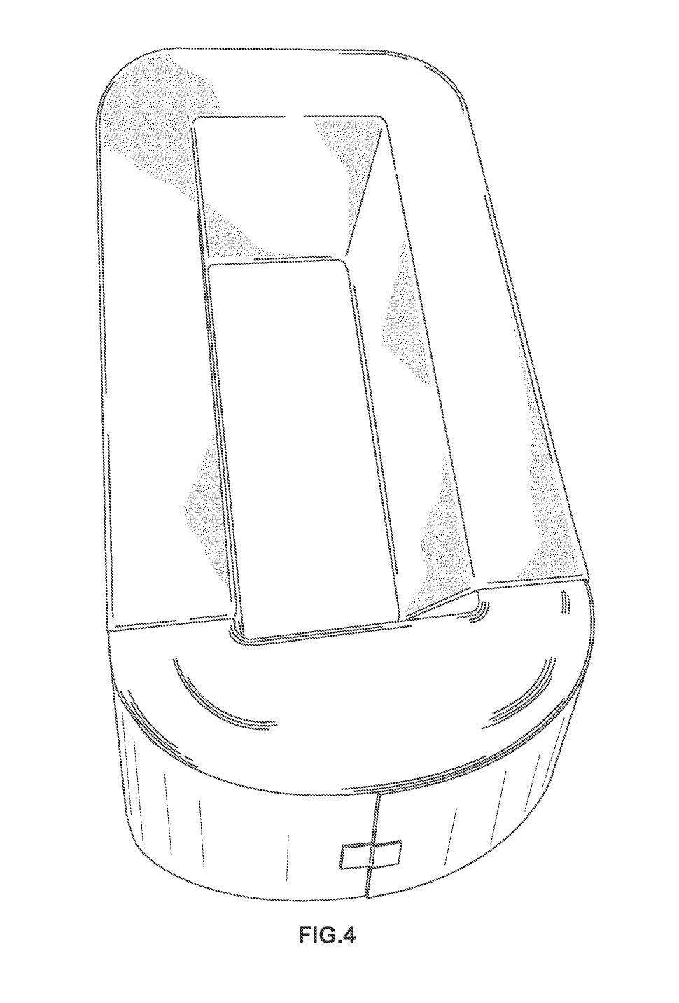

FIG. 3 illustrates a transformer core 40 that may be manufactured from a plurality of strip stacks, such as a plurality of strip stacks illustrated in FIGS. 1 and 2. As illustrated, this jointed core 40 includes a plurality of spirally wound metallic strip packets that may be initially wound as on a round or rectangular mandrel. The circumference of the circular mandrel or the parameter of a rectangular mandrel is determined by the size of a core window 42 desired to accommodate the high and low voltage coils of a finished transformer. Similarly, the number of spirally wound metallic strip packets is determined by the ultimate power rating of the transformer and a design-specified maximum buildup dimension for a core leg. For example, typically the buildup dimension defines the core leg thickness and hence the overall transformer design is based on a specific cross sectional area that assumes a density factor for the amorphous metal material. However, as those of ordinary skill in the art will recognize, the number of desired amorphous metal strips may be determined by a particular electrical characteristic, electrical property, or a desired dimension of the amorphous metal core as will be described in greater detail herein.

The core must be provided with a support fixture that provides core support and core containment during subsequent annealing and testing procedures. For example, referring now again to FIG. 3, the magnetic core, generally designated 40, includes a plurality of individual metallic strip packets that have been cut to form a joint 62. As illustrated, the plurality of amorphous metallic strip packets are shaped into a metallic transformer core 40, wherein the metallic transformer core comprises a back end or closed end 46 and an overlap or front portion or end 50 of the core 40. A first leg 54 of the amorphous core extends from the back 46 of the core to the front of the core while a second leg 58 also extends from the back of the core to the front of the core.

Because of the flexibility of the amorphous metal strip packets, one or more support fixtures 64, 80 may be employed so as to maintain the overall integrity and shape of the annealed core 40. For example, in this illustrated support fixture arrangement, the first support fixture 64 comprises two long outer support plates 66, 68, two long inner support plates 72, 74, two narrow outer support plates 78, 80, and two narrow inner support plates 84, 86. Additionally, a second support fixture 90 in the form of a metallic band is provided along the outer circumference of the core and holds the various support plates of the first support fixture 64 in place.

As illustrated in phantom at 98, a joint 62 located near the open or back end 50 of the core permits a portion of the amorphous core 40 (also referred to as the overlap of the core) to be opened so as to receive coils during a transformer assembly. As best illustrated schematically in FIGS. 1 and 2, the packets are divided into a plurality of groups of packets and several sets of groups of packets. In FIGS. 1 and 2, approximately 7 laminations have been illustrated as defining a group of laminations but it should be understood that the number of metallic strips in a group could be from between about 5 and 30 metallic strips and is preferably approximately 30 metallic strips. As previously discussed, each group of metallic strips is offset laterally from its adjacent group of metallic strips and a certain number of these groups of strips are defined herein as a set of groups. In the illustration of FIGS. 1 and 2, three groups of strips constitute a set of groups but it should be understood that the number of groups of strips in a set of groups of strips is preferably between about 5 and 25 groups before it is necessary to step back or forward with respect to the direction of the spiral to repeat the sequence. The number of groups of strips in a set of groups is essentially controlled by the length of the first leg 54 of the rectangular core before that first leg begins to curve to form the first and second side legs 56, 60 of the magnetic core 40.

Once the core, such as the core and support structure illustrated in FIG. 3, has been annealed, the core will undergo certain electrical testing (as generally described above) while the support fixtures 64, 90 remaining in place. Assuming that the annealed core passes these various electrical tests, the support fixtures 64, 90 must then have to be removed so that the tested annealed core can be formed or shaped so that it retains its annealed shape as the core is prepared to be shipped or assembled in a transformer.

In one preferred method of maintaining the annealed core in its desired annealed shape, one or more caps may applied over at least portion of at least one of the legs of the core. That is, in reference to the core illustrated in FIG. 3, one preferred method of maintaining the annealed core in its desired annealed shape, is to provide a least one cap over at least portion of an upper surface or a cast end the first leg 54 of the core 40.

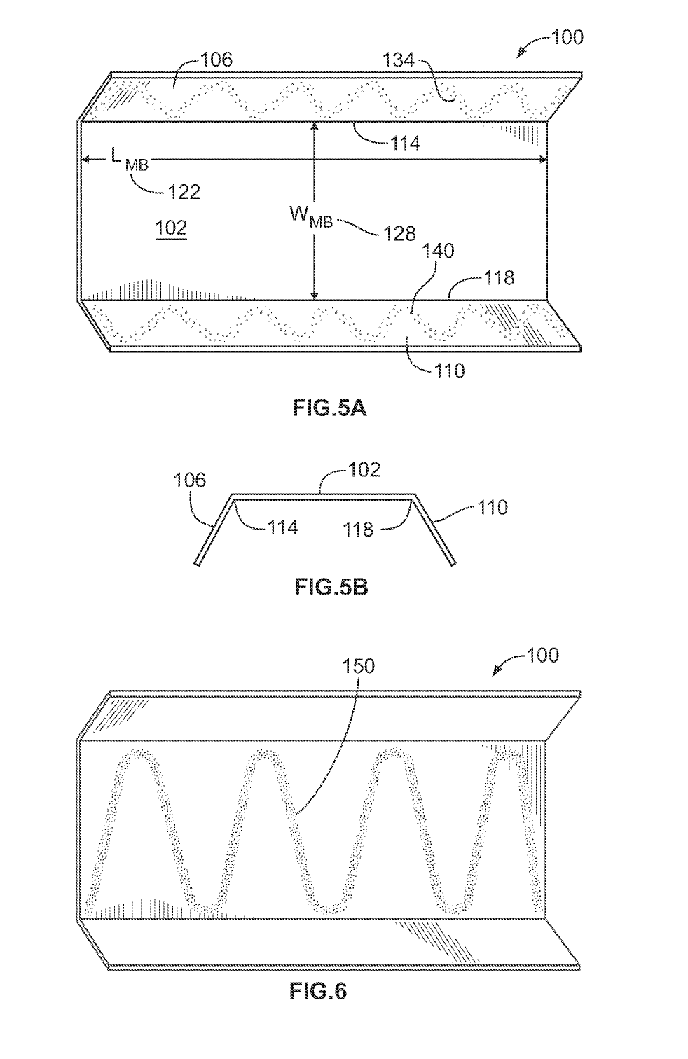

As just one example, FIG. 5A illustrates one such cap 100 that can be used to shape an annealed transformer core, such as the core 40 illustrated in FIG. 3. As shown, the cap 100 comprises a generally rectangular shape and comprises a main body 102 extending along a length of the main body that is represented by L_{mb} 122. Preferably, the main body length L_{mb} 122 of the generally rectangular cap is generally equivalent to the length of one of the legs of the annealed core, such as the length of the first leg 54 of core 40.

As those of ordinary skill in the art will recognize, the cap 100 may comprise alternative lengths, sizes and/or shapes. As just one example, the cap 100 may comprise just a main body 102 without either a first longitudinal extending flap 106 or a second longitudinal extending flap 110.

As yet another example, the presently disclosed cap arrangements may be used with single phase or three phase (i.e., Evans style) transformers. For example, in a typical three phase transformer design, the transformer comprises basically two smaller cores of equal size diameter and cross-sectional area, together encircled by a larger core of equal cross-sectional area. In such a configuration, a single cap arrangement (such as the cap 100 illustrated in FIG. 5A) may be used to provided stability and/or dimensional definition to both a first leg of a first core and a an adjacent first leg of a second core. The first leg of the second core may comprise either a leg of the smaller encircled core or a leg of the larger core of equal cross-sectional area.

As illustrated in FIG. 5A, the cap main body 102 comprises two main body long creases 114, 118 that define a first longitudinally extending flap 106 and a second flap longitudinally extending flap 110. As just one example, the two main body long creases 114, 118 may be formed by running a razor or other blade or cutting element along the length of the main body 102 so as to create a shallow score. Preferably, the cap 100 may be produced by folding the edges such that a width of the main body represented by W_{mb} 128. More preferably, width of the main body represented by W_{mb} 128 is designed to match the specified maximum buildup dimension for a transformer core leg.

In one preferred arrangement, the cap 100 may be produced from an oil-compatible, paper-like material that will accept being folded so that the material maintains a sharp edge. In a preferred arrangement, the cap 100 comprises an insulation material, such as a Nomex® insulation material. Such an insulation material may preferably comprise a Nomex® paper having a thickness from approximately 0.005″ to approximately 0.050″.

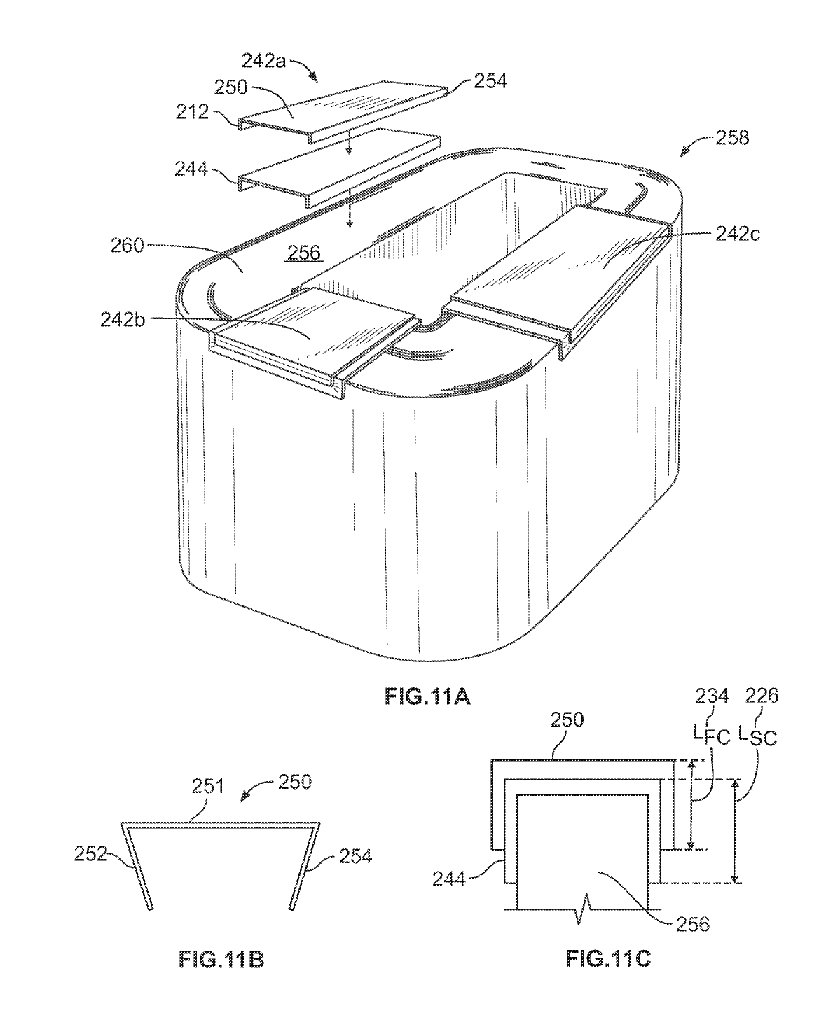

The cap 100 may comprise a piece of material that covers the amorphous core along the cast edge of the amorphous material and attached to both the inside and outside of the core on either side of the cast edge. Further, the cap 100 may be attached to the cast edge using some type of adhesive or an adhering mechanism—such as tape, glue, epoxy, mechanical stitching, etc. or some combination thereof. Such an adhesive prevents the cap material (and perhaps an over cap material as will be discussed with respect to FIGS. 11A-C) from being easily detached from the sides of the core. One advantage of using such a cap is that the cap (i.e., the cap main body width W_{MB}) provides a limit to an amount of core wall expansion so that the maximum buildup stays within a desired specification. This may be accomplished without applying any unnecessary pressure when the core leg is straight—as it is when the core is installed in the transformer coil. As such, by using a cap having a constant main body width W_{MB}, the resulting batch of annealed cores will result in a greater performance consistency from core to core within the batch.

As such, the material wall is allowed to expand to maximum buildup dimension, which reduces stresses in the amorphous packets, resulting in better overall core and therefore transformer performance. This can also reduce or eliminate the need for inserting stuffing between the core wall and the end wall in the transformer. Since the overall leg width is quite exact and repeatable, a slight interference fit can be designed for core and coil which therefore can eliminate the need for stuffers.

Another advantage of such a cap configuration is that the core will be more easily inserted into the coil. If packing is necessary to wedge between core leg and coil wall, it will now be easier to insert wedges as there will be no hanging up on uneven areas of the core wall that may sometimes arise if an epoxy layer is used. For example, taped core walls can be misshapen (i.e., they may be crooked or not straight) Forcing crooked or not straight legs into straight coils can induce stresses in the collection of amorphous ribbon thereby causing core performance losses.

Once the cap 100 is folded so as to form a crease between the main body 102 and the first and second longitudinal flaps 106, 110, the cap can be pushed onto a long edge of the core, and then affixed using a piece of tape. However, in one alternative arrangement, an epoxy, tape gum, combination thereof, or alternative adhesive may be applied to at least a portion of an underside of the cap before the cap is affixed to the annealed core. For example, as illustrated in FIG. 5A, a first bead 134 of an epoxy or alternative adhesive may be applied to the first long extending flap 106 and a second bead 140 of an epoxy or alternative adhesive may be applied to the second flap 110. Alternatively, and as illustrated in FIG. 6, a first bead 150 of an epoxy or alternative adhesive may be applied along the main body 102 of the cap 100.

One important aspect of the cap 100 is the sharp bends or folded creases 114, 118 that define the first and second longitudinally extending flaps 106, 110. One advantage of such sharply defined bends is that they allow a core manufacture to quickly and efficiently locate and line up the edge of the core leg and apply the cap 100 in a minimum of time in an exact location. This will allow the amorphous material in the core leg to experience the smallest amount of compression required to meet the maximum buildup specification.

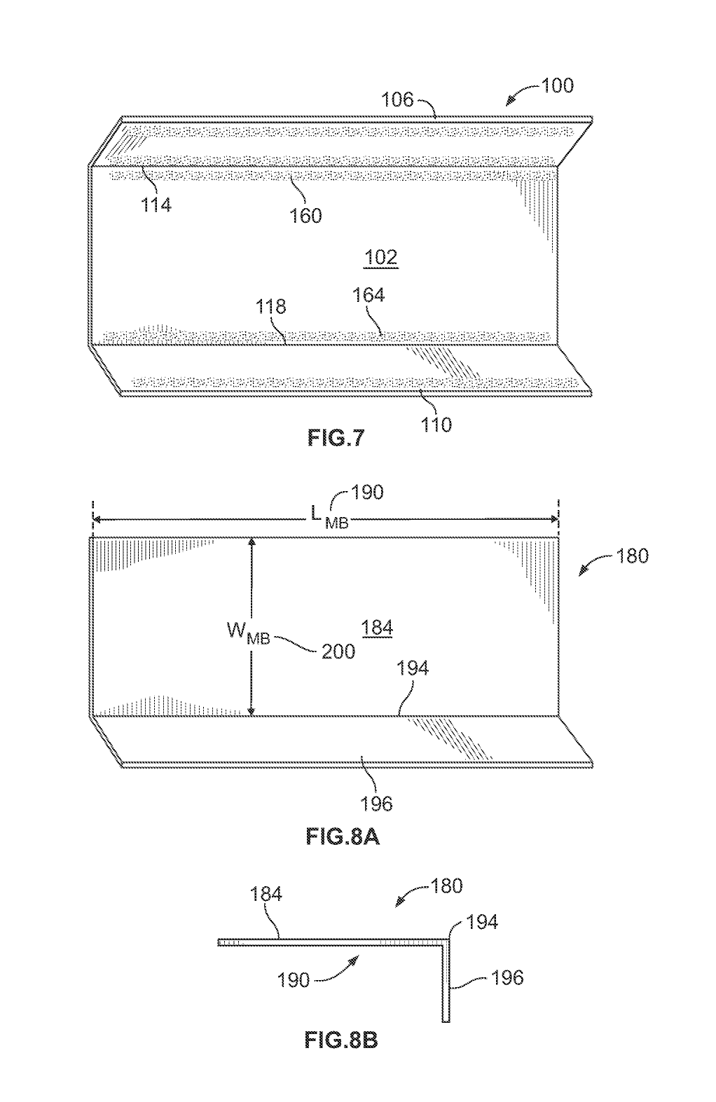

FIG. 7 illustrates yet another alternative cap arrangement. In yet another alternative embodiment, and as illustrated in FIG. 7, the cap 100 may be affixed to the leg of the core with a combination of both an amount or a bead of an epoxy or an amount or a bead of an adhesive. As just one example, and as illustrated in FIG. 7, a first bead 160 of an epoxy may be provided along the first longitudinal crease 114 of the cap 100 and a second bead 164 of an epoxy may be provided along the second longitudinal crease 118 of the cap 100. In addition, a first amount or a bead 168 of an adhesive may be provided along the first longitudinally extending flap 106 and a second amount or bead 174 of an adhesive may be provided along said second longitudinally extending flap 174 of the cap 100. With such an arrangement, once the adhesive and the epoxy cures, since both the adhesive and the epoxy reside only on outside edges of the cast edge of the core leg, the core leg to experience the smallest amount of compression required to meet the maximum buildup specification while also allowing the amorphous core to achieve its desired magnetostrictive motion.

FIG. 8A illustrates yet another alternative cap arrangement 180 that can be used to shape an annealed transformer core, such as the core 40 illustrated in FIG. 3. FIG. 8B illustrates a side view of the alternative cap arrangement 180 illustrated in FIG. 8A.

Referring now to both FIGS. 8A and 8B, and similar to the cap arrangement 100 illustrated in FIG. 5A, this alternative cap arrangement 180 comprises a generally rectangular shape and comprises a main body 184 extending along a length of the main body and may be represented by L_{MB} 190. Preferably, the main body length L_{MB} 190 of the generally rectangular cap is generally equivalent to the length of one of the legs of an annealed core, such as the length of the first leg 54 of core 40 illustrated in FIG. 3. As those of ordinary skill in the art will recognize, the cap 180 may comprise alternative lengths, sizes and/or shapes.

As illustrated in FIG. 8A, and in contrast to the cap arrangement 100 illustrated in FIG. 6A, the cap main body 184 comprises one length long crease 194 that defines a first longitudinally extending flap 196 and generally comprises an L-shaped cap. Preferably, the cap 180 may be produced by folding an edge of the flap 196 such that the now defined crease 194 defines a width of the main body represented by W_{MB} 200. In one preferred arrangement this main body width W_{MB} 200 will be generally equal to a specified maximum buildup dimension for the core leg. Alternatively, this main body width W_{MB} 200 will be generally less than a specified maximum buildup dimension for a core leg. In such a situation where the width of the main body W_{MB} 200 is less than the maximum buildup dimension, and as discussed below, two cap arrangements 180 may be used along the leg of a core where the cap arrangements 180 are placed one over the other with the respective flaps facing one another.

One advantage of using cap 180 comprising a single flap is that is may be used with smaller core configurations and hence a smaller leg core width. In addition, in one cap configuration, two such L shaped caps may be used where a first alternative cap 180 is provided along the cast edge of the core with the flap 196 extending along the inner surface of the core leg. Similarly, a second such L shaped alternative cap 180 may be provided along the main body with the flap 196 extending along the outer surface of the core leg. In such an arrangement, the first cap 180 may comprise a piece of material that covers the amorphous core along the inner cast edge of the amorphous material and the second cap 180 may comprise a piece of material that covers the amorphous core along the outer cast edge of the amorphous material.

One advantage of using such a multiple cap arrangement is that it provides a limit to the amount of core wall expansion so that the maximum buildup stays within a desired specification. This may be accomplished without applying any unnecessary pressure when the core leg is straight—as it is when the core is installed in the transformer coil.

As those of ordinary skill in the art will recognize, alternative epoxy and adhesive methods may also be used to fixedly attach the cap to the leg of the transformer core.

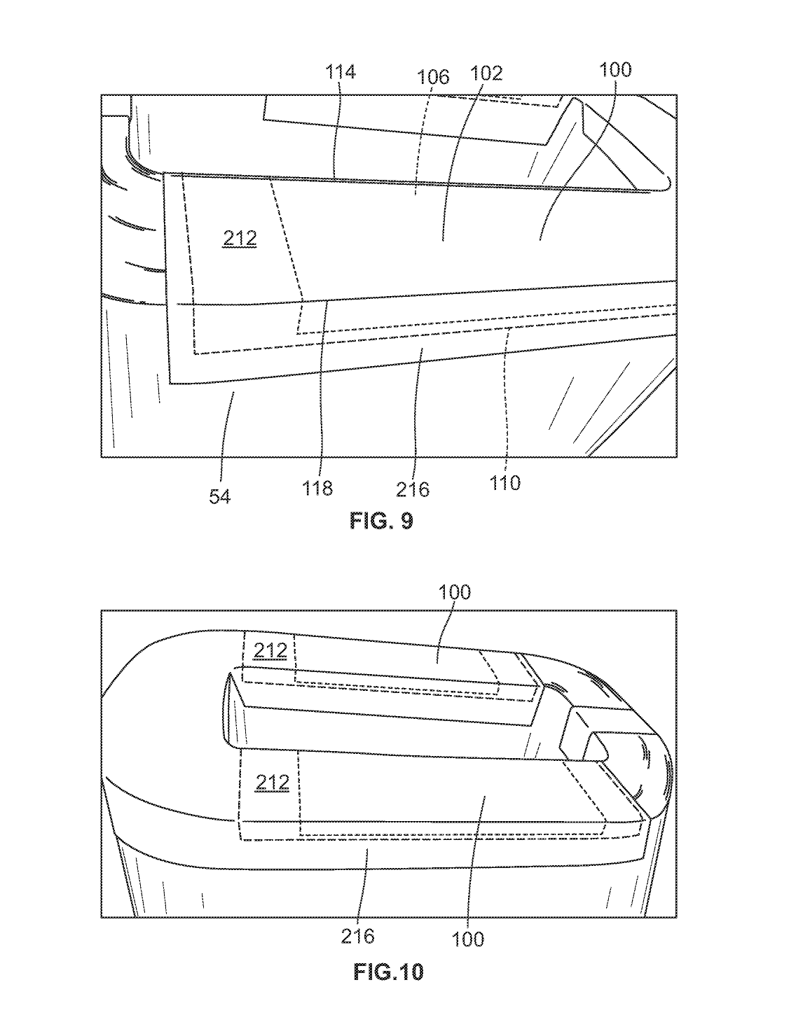

After the epoxy and/or adhesive has been applied to the cap or multiple caps, the cap or multiple caps may then be affixed along a leg of the annealed core. For example, FIG. 9 illustrates a cap (such as the cap 100 illustrated in FIG. 5A) affixed along a first leg 54 of an annealed amorphous core, such as the core 40 illustrated in FIG. 3. As illustrated in FIG. 9, the cap 100 is affixed along the first long leg 54 of the core with the first longitudinal extending flap 106 extending along an inner surface of the core and the second longitudinal extending flap 110 extending along the outer surface of the core 40. Advantageously, the cap 100 is affixed along the long leg of the core 40 with the first longitudinal extending flap 106 extending along the inner surface and the main body 102 of the cap is affixed along the cast edge of the core such that the first longitudinal crease 114 between the main body and the first flap maintains the straightness of the core inner surface. Similarly, the cap 100 is affixed along the long leg of the core 40 with the second longitudinal extending flap 110 extending along the outer surface of the core such that the second longitudinal crease 118 between the main body 102 and the second flap 110 maintains the straightness of the core inner surface while still allowing the core to achieve a certain level of magnetostrictive forces induced by the core.

One advantage of using such a cap 100 is that the first and second creases or bends 114, 118 allows a user to locate the caste edge of the core leg 54 and to apply the cap 100 in a minimum amount of time in an optimum location. Optimum cap placement along the leg cast edge allows the amorphous material of the core leg to experience the smallest amount of compression required to meet the maximum buildup specification.

Another advantage of the cap is that the cap provides a limit to the amount of core wall expansion so that the buildup stays within a certain desired specification, without applying any unnecessary pressure when the leg of the core is straight—as may occur when the core is installed in the transformer coil.

As also illustrated in FIG. 9, tape may be used to further secure the cap to the core. For example, where an adhesive and/or epoxy is provided on the cap main body and/or the cap flaps, tape may be used to properly secure the cap before the adhesive or the epoxy cures. As just one example, tape 212 can be provided along the outer surface of the cap, for example, at the front end of the core as well as at the back end of the core. In addition, tape 216 may be used to secure a bottom portion of the longitudinal flap 110 and along the outer surface of the core leg 54. One advantage of using tape in this method is that it allows the transformer core to me moved and further processed while any of the epoxy or adhesive cures.

FIG. 10 illustrates a perspective view of an annealed core comprising a first and a second cap. As can be seen, the annealed core is provided with a first cap (such as the cap illustrated in FIG. 5A provided along a first core leg and a second cap (such as the cap illustrated in FIG. 5A) along a second core leg. As those of ordinary skill in the art will recognize, alternative cap arrangements may be used on a single transformer core. As just one example, the annealed core illustrated in FIG. 10 may provided with a first cap (such as the cap illustrated in FIG. 6A provided along the first core leg and the second cap (such as the cap illustrated in FIG. 7, 8, or 9A) along the second core leg.

As can also be seen from FIG. 10, an area on the left side which is the “back” of the core which cannot be opened in the same fashion as can the end that is laced (the overlap of the core). Preferably, the back of the core will be covered with some type of material so as to prevent amorphous chips from escaping from the core (and perhaps, into a fluid of a transformer). In this preferred arrangement, the back of the core is provided with various strips of tape, or coated with an adhesive and/or epoxy. Alternatively, the back of the core could be taped in a similar manner, where the edges of the cap of covered with the tape.

If it is determined that a greater cap rigidity is desired or specified for a particular size transformer core, then a thicker cap material can be applied. As just one example, the cap material could comprise an insulation material comprising a thickness from approximately 2 to approximately 30 mils. Additional rigidity may also be obtained by depositing a bead of epoxy along an inside of the cap before the cap is placed on the core leg as described above.

Yet another alternative core shaping arrangement may be used for more core stability. For example, FIG. 11A illustrates a perspective view of yet another alternative amorphous core cap arrangement 242 for shaping an annealed core 258, such as the core illustrated in FIG. 3. For example, FIG. 11A shows an alternative amorphous core cap arrangement 242a comprising a first cap 244 and a second cap 250 where the second cap 250 is positioned over the first cap 244, preferably positioned in a piggy-back style along at least a portion of the first cap 244. In one preferred arrangement, the core 258 may be provided with three such cap arrangements 242 along a top surface of the core: two such cap arrangements 242 a,c provided along the first and second long legs of the core and a third such cap arrangement 242b provided along the side leg or back side of the core.

Specifically, and as shown in FIG. 11A, a first cap 244a is provided along a cast edge 256 of a first core leg 260 of the core 258. A second cap 250 is then placed over at least a portion of the first cap 244, essentially holding the first cap 244 in place. In this alternative piggy-back type cap arrangement 242a, the first cap 244 resides along the top surface of the first leg 260 of the transformer core, similar to the first cap 100 illustrated in FIG. 5A. Alternative first cap and epoxy/adhesive combinations and arrangements, such as those herein described and illustrated for example in FIGS. 6-8 may also be used to affix the first cap 244 and/or the second cap 250 to the core 258.

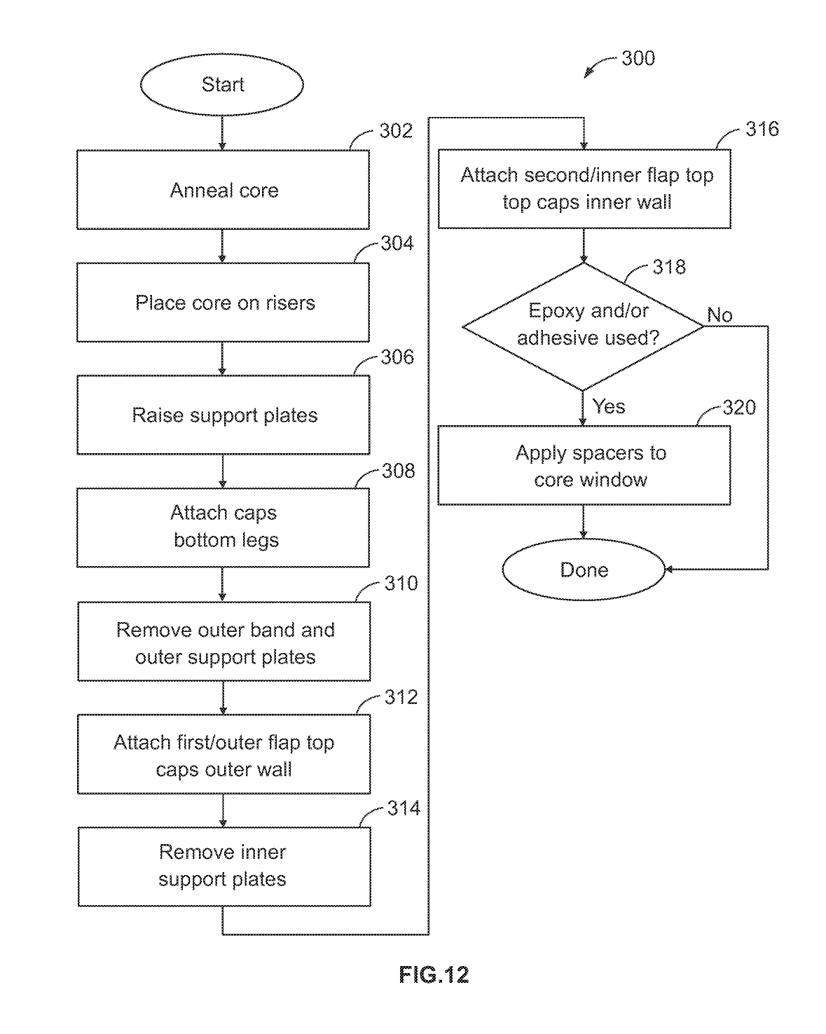

In FIG. 11A, the first cap 244 preferably comprises a non-conductive material, such as an insulation material, such as a Nomex® paper. Preferably, the second cap 250 comprises a cap having certain ductile or pliable properties. More preferably, the second cap 250 comprises a metallic cap and comprises both a first longitudinally extending flap 252 and a second longitudinally extending flap 254, similar to the cap arrangement 100 illustrated in FIG. 5A. For example, such a metallic cap may comprise grain-oriented silicon steel, cold-rolled steel, galvanized, or any metal or composite offering strength. FIG. 11B illustrates a side view of one arrangement of a preferred second cap 250 that can be used with the cap arrangement illustrated in FIG. 12A. As illustrated in FIG. 11B, the second cap 250 comprises a main body 252 with the first flap and the second flat 252, 254 extending therefrom. In one preferred arrangement, the first and second flaps 252, 254 of the second cap 250 are biased inwardly or towards one another. In this manner, when the second cap 250 is placed on at least a portion of the first cap 244, the first and second inwardly biased flaps 252, 254 compress or exert an inwardly directed force onto the first cap flaps 246, 248 thereby retaining both the first cap and the second cap in place along the first leg 260 of the core 258. In one preferred arrangement, a small amount of epoxy and/or adhesive may be provided between the second cap 250 and the first cap 244 and/or between the first cap 244 and the cast edge 256 of the first leg 260.

FIG. 11C illustrates a cross sectional view of the first and second cap arrangement illustrated in FIG. 11A. FIG. 11C illustrates a side view of the piggy back cap arrangement with the second cap 250 seated over the first cap 244. As illustrated, the first cap 244 has both a first and a second cap of length L_{FC} 234. Similarly, the second cap comprises a first and a second flap having a length L_{SC}236. As illustrated, the length of the first and second flap L_{FC} 234 of the first cap 244 is longer than the length of the first and second flap L_{SC} 236 of the second cap 250. As can be seen from FIGS. 11B and C, the first and second flaps of the second cap are configured to provided an inwardly directed bias so as to maintain a pressure upon the first cap (and hence the width of the leg of the core) when disposed over the first cap.

Providing such an overlapping second cap arrangement 242 provides certain advantages. For example, one such advantage of such a dual cap configuration is that such a configuration (for certain sized annealed cores) may not require the use of tape for either the first cap or the second cap. Providing such a cap arrangement therefore results in labor savings as well as cost savings during the core shaping process.

Alternatively, if epoxy and/or adhesive were to be applied inside the first cap 244, the double cap can be placed on the core without the need for taping the cap to the core. If epoxy and/or adhesive were applied, the inwardly created pressure of the first and second cap flaps 252, 254 of the second cap 250 can be configured and dimensioned so as to hold the first and second caps in place until the epoxy cures.

Preferably, when a metal over-cap is used, the length of the paper cap flaps should be longer than the length of the metal cap flaps. For example, returning to FIG. 11A, as illustrated, the length of the first paper cap flap is slightly longer than the length of the first metal cap flap that overlaps the first paper cap flap. In this manner, the metal over cap will be electrically insulated from the steel that is provided along the outside of the core. If the metal in the cap were to come into direct contact with the silicon steel, a short could be created.

FIG. 11A illustrates three similar dual cap arrangements 242 provided along the first and second legs and the short legs. However, as those in skill in the art will recognize, alternative cap arrangements may be used along the various legs of the core. As just one example, the cap arrangement illustrated in FIG. 5A may be used on the short leg of core 258 illustrated in FIG. 11A while the dual configuration 242 may be used along the long legs of the core 258 (as illustrated). Other alternative cap arrangements as disclosed herein may also be used.

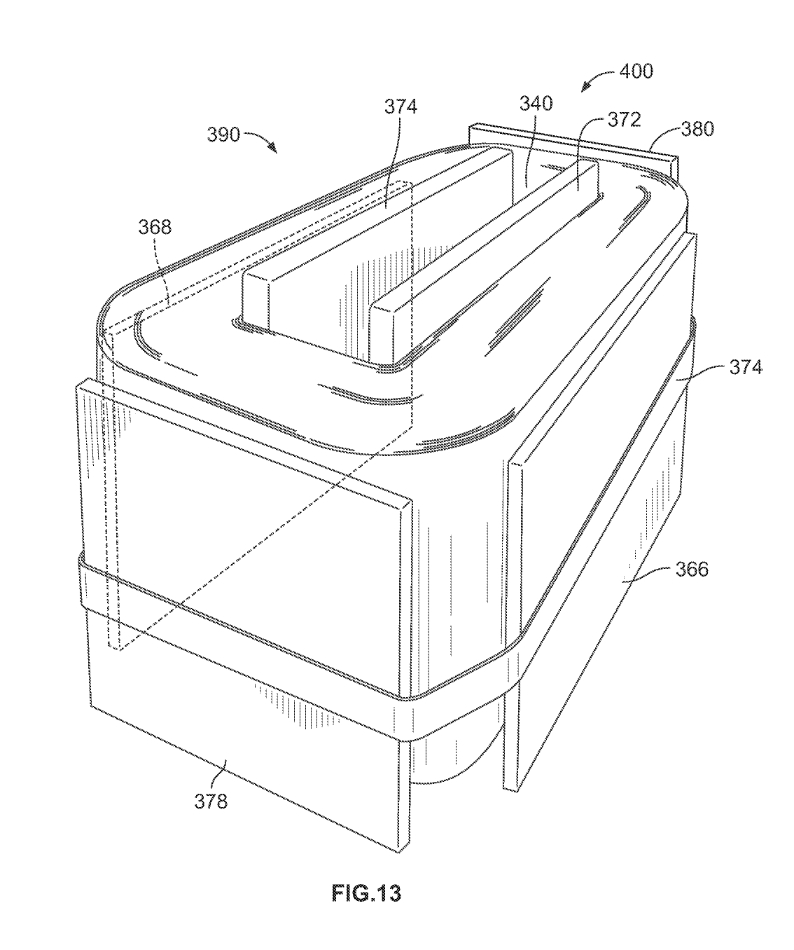

The following describes one preferred method for utilizing a plurality of caps to form and shape a metallic amorphous annealed core. For example, FIG. 12 illustrates one exemplary flow chart 300 illustrating certain process steps that may be undertaken for forming or shaping an annealed amorphous core comprising at least one cap, such as those cap arrangements described in detail herein. For example, at a first process Step 302, the amorphous core is annealed and then tested for certain electrical properties. FIG. 13 illustrates such a core that has been annealed, that has passed its electrical tests, and is now ready to be shaped and formed for transportation. The annealed core 400 is shown with a first support fixture 374 (comprising a wire cable) and a second support fixture 390 (comprising a plurality of support plates 366, 368, 372, 374, 378, and 380).

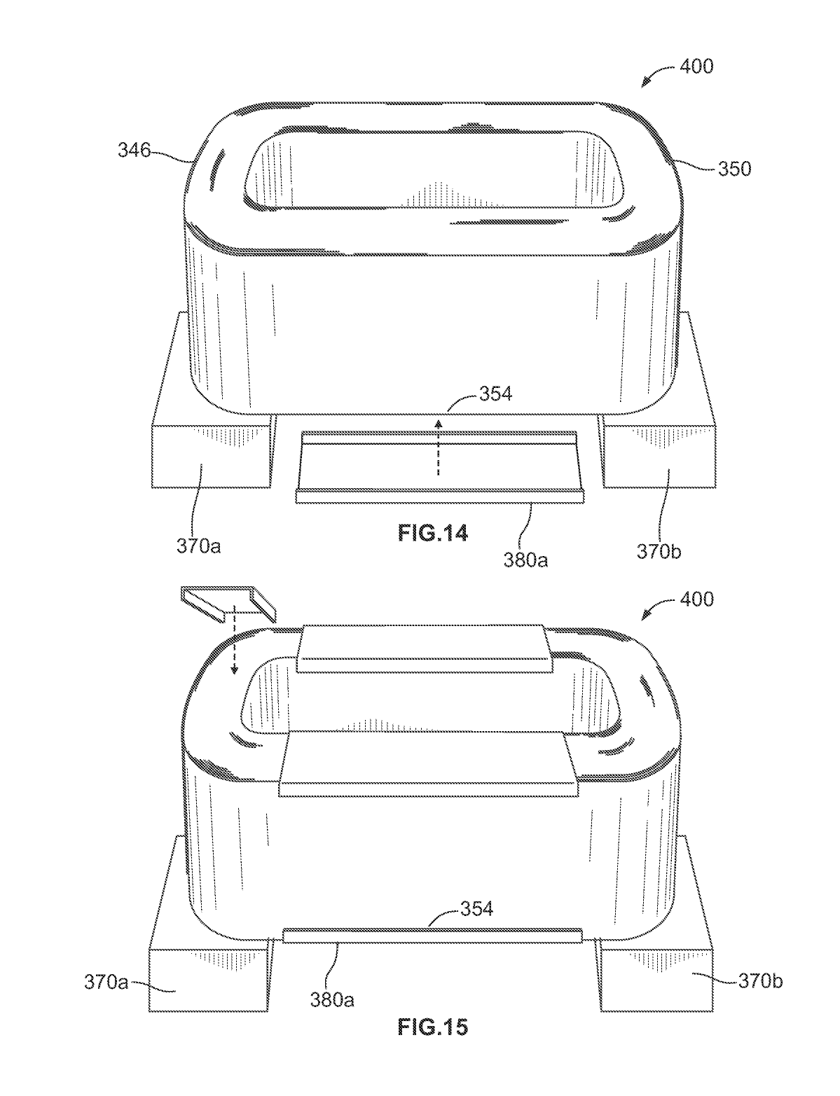

At the second process Step 304, the annealed core 400 is placed on risers. Such a process Step 304 is illustrated in FIG. 14 where the core 400 is places on risers 370 a,b. As illustrated in FIG. 14, an annealed core 400 is placed so that the core's front end (i.e., its lacing end) 350 and its back end (i.e., its backwall) 346 sits upon risers 380 that reside along a work surface. (For ease of explanation, the support plates have been omitted from FIGS. 14 and 15). Preferably, this work surface comprises a turn-table. The risers 380 a,b lift a bottom portion of the annealed core off of the work surface. Lifting the bottom surface of the core off of the work surface allows open access to both the first and second bottom sides of the annealed core.

Then, as illustrated in Step 306 in flow chart 300, the first and second outer support plates 366, 368 and the first and second inner support plates 372, 374 forming the various walls of the core are then raised in the direction away from the work surface. As just one example, these support plates may be raised approximately 1.0″ to about 2.0″ from their annealed position (as illustrated in FIG. 13) so as to expose enough of the bottom edge of the core to allow cap placement. Raising the support plates in this amount of distance allows access to the first and second bottom legs of the core while maintaining the containment and shape of the core.

At Step 308, a first and a second cap 380a,b may be attached to a bottom surface of the first and the second legs 354, 358 of the core, respectively. The first and second caps 380a,b may be attached as described herein. For example, as illustrated in FIG. 14, a first cap 380a is illustrated as being attached to a bottom surface of the first leg 354 and a second cap 380b is illustrated as being attached to a bottom surface of the second leg 358.

Once the bottom first and second caps have been attached at Step 308, at Step 310, the outer band 374 holding the outer support plates in place can be cut and removed, thereby allowing the outside support plates to be removed. This step is illustrated in FIG. 14 where the annealed core is now shown with the first and second caps provided along the bottom case edges of the first and second legs of the core.

Then, at Step 312, one wall at a time, an outer flap of the first top cap is located and attached to the outside of the each wall of the annealed core. For example, the outer flap of a first top cap is attached to the outside of the first wall and the outer flap of a second top cap is attached to the outside of the second wall. Thereafter, at Step 314, the first and second inner plates 372, 374 can then be removed by being pulled up, and removed from the window 342 of the core 400. Then, one at a time, at Step 316, the inner flaps of the first and second top caps can then be attached to an inside surface of each respective wall of the core.

As described herein in detail, an adhesive and/or an epoxy may be utilized to provide a heightened degree to stability to the cap arrangement utilized to shape the core. Returning to the method illustrated in FIG. 12, if it is determined at Step 318 that an adhesive and/or epoxy has been placed on the cast edge of the core, then the process would proceed to Step 320. At Step 320, if an adhesive and/or epoxy is placed on the cast edge of the core, then it is preferable to place one or more spacers inside the core window, between the two inner most walls of the core to as to keep the side walls straight until the adhesive and/or epoxy cures. These spacers can serve to keep the legs of the core straight and parallel to one another until the epoxy is cured.

Accordingly, Applicants' presently proposed method and apparatus is directed to shaping or forming an amorphous metal transformer core that is cost effective to manufacture, that has low energy losses, that is energy efficient, and is more environmentally friendly than other known methods. Applicants' disclosed methods and apparatus is also directed to an amorphous metal transformer core in which the difficulties of handling, processing, and shaping the amorphous metal cores to perform the manipulative steps of the fabrication process are reduced and the mechanical stresses induced into the amorphous metal strips and hence the core during its fabrication process are reduced. As such, the disclosed methods and apparatus allows the amorphous ribbons to move in response to the magnetorestrictive forces induced by a transformer conductor coil and therefore increases overall transformer core performance. In addition, the presently disclosed systems and methods of shaping and forming of the amorphous metal core process is simplified since it does not require the labor intensive steps of taping, providing an epoxy, and repeated curing of the epoxy. As such, the presently disclosed methods and apparatus eliminates certain costly and labor intensive steps as discussed in greater detail above.

Exemplary embodiments of the present invention have been described. Those skilled in the art will understand, however, that changes and modifications may be made to these embodiments without departing from the true scope and spirit of the present invention, which is defined by the claims.

As just one example, an alternative amorphous core cap may comprise a thermoplastic material, such as a thermo-softening plastic, or other similar polymer that becomes pliable or moldable above a specific temperature and returns to a solid state upon cooling. With such a thermoplastic cap arrangement, while keeping the forming support plates on the amorphous core during the capping process so as to maintain wall straightness and buildup, an epoxy or alternative adhesive may deposited on the cast edges where the thermoplastic material is to be placed. The areas with adhesive may then be covered with a strip of a thermoplastic material. In one preferred arrangement, the strip of thermoplastic material may be slightly wider than the wall buildup centered along the wall length, corners, and backwall. The amorphous core with the thermoplastic cap may then placed under a heating element in order to melt the thermoplastic material. In such a manner, the edges of the thermoplastic material will preferably overhang the core wall and bend over against the core wall. Once melted, the core may then be cooled. The core can then be flipped over and this thermoplastic capping process may be repeated on the other side core. The thermoplastic material may also be trimmed to the dimensions of a preferred buildup, if desired.

In yet another alternative cap arrangement, a cap may comprise a heavy textile material, such as canvas or other similar cloth or flexible woven material. Similar to the thermoplastic cap arrangement generally described above, while keeping the forming and support plates on the core so as to maintain wall straightness and buildup, an epoxy or an alternative adhesive may be placed on the cast edge of the core where the textile material is to be placed. Once the adhesive has cured, an overhang material may be attached to the core wall with adhesive, or trimmed away.

In yet another alternative cap arrangement, a cap may be formed using a heavy textile material as discussed above but in this arrangement, the textile may be attached to the core using adhesive only on a flap or flaps of the textile cap. The forming or support plates may be kept on the core during the capping process so as to maintain wall straightness and buildup as discussed herein.

I claim:

1. An amorphous metallic transformer core comprising;
a plurality of amorphous metallic strip packets, said plurality of amorphous metallic strip packets shaped into a metallic transformer core;
said metallic transformer core comprising
a back of said core,
an overlap or front of said core
a first leg of said amorphous core extending from said back of said core to said front of said core, and
a second leg of said amorphous core extending from said back of said core to said front of said core,
a first cap provided along at least a portion of said first leg of said amorphous core,
said cap providing rigidity to said plurality of amorphous metallic strip packets contained within said leg of said amorphous core.

2. The amorphous metallic transformer core of claim 1 further comprising a second cap provided along said second leg of said transformer core.

3. The amorphous metallic transformer core of claim 1 further comprising an adhesive provided between at least a portion of said first cap and at least a portion of said first leg.

4. The amorphous metallic transformer core of claim 3 wherein said cap comprises at least one longitudinally extending flap.

5. The amorphous metallic transformer core of claim 4 wherein said adhesive is provided along at least a portion of a first flap of said first cap.

6. The amorphous metallic transformer core of claim 1 further comprising an epoxy provided along at least a portion of one flap of said first cap.

7. The amorphous metallic transformer core of claim 1 further comprising an adhesive provided along at least a portion of a main body of said first cap.

8. The amorphous metallic transformer core of claim 1 further comprising an epoxy provided along at least a portion of a main body of said first cap.

9. The amorphous metallic transformer core of claim 1 further comprising a second cap provided along at least a portion of said first cap.

10. The amorphous metallic transformer core of claim 9 wherein said second cap comprises a metallic cap.

11. The amorphous metallic transformer core of claim 9 wherein an adhesive is provided between at least a portion of said first cap and said second cap.

12. The amorphous metallic transformer core of claim 1 wherein said transformer core comprises
a combination of amorphous and non-amorphous metal strips.

13. The amorphous metallic transformer core of claim 1 wherein said first cap comprises an insulation material.

14. The amorphous metallic transformer of claim 1 wherein said first cap comprises
a generally rectangular main body and at least one flap provided along a longitudinal edge of said main body.

15. The amorphous metallic transformer core of claim 1 wherein said first cap is configured to comprise at least one longitudinal straight edge, such that when said first cap is provided along said first leg of said amorphous core,
said at least one longitudinal straight edge of said cap maintains said longitudinal edges of said plurality of amorphous metallic strip packets contained within said leg of said amorphous core straight.

16. The amorphous metallic transformer core of claim 1 wherein said first cap comprises a layer of epoxy.

17. The amorphous metallic transformer core of claim 16 wherein said layer of epoxy covers at least a portion of a cast edge of said first leg of said core.

18. The amorphous metallic transformer core of claim 1 further comprising tape wound around the core to enhance core containment.

19. The amorphous metallic transformer core of claim 1 wherein said transformer core comprises an annealed amorphous metallic transformer core.

20. The amorphous metallic transformer core of claim 1 said cap providing dimensional definition to said plurality of amorphous metallic strip packets contained within said leg of said amorphous core.

21. The amorphous metallic transformer core of claim 1 wherein said transformer core is for use with a three phase transformer.

22. The amorphous metallic transformer core of claim 1 wherein said cap comprises a thermoplastic material.

23. The amorphous metallic transformer core of claim 1 wherein said cap comprises a textile material.

22. A method of shaping an amorphous metal core, the method comprising the steps of:
forming a plurality of amorphous metallic strip packets into a transformer core;
said metallic transformer core comprising
a back of said core,
an overlap or front of said core
a first leg of said amorphous core extending from said back of said core to said front of said core, and
a second leg of said amorphous core extending from said back of said core to said front of said core, and
providing a first cap provided along said first leg of said amorphous core,
said cap providing rigidity to said plurality of amorphous metallic strip packets contained within said leg of said amorphous core.
